(19) United States
(12) Patent Application Publication
(10) Pub. No.: US 2008/0031110 A1
(43) Pub. Date: Feb. 7, 2008

(54) RECORDING DEVICE AND RECORDING METHOD

(75) Inventor: Minako MORIO, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/737,985

(22) Filed: Apr. 20, 2007

(30) Foreign Application Priority Data
Jun. 30, 2006 (JP) 2006-182102

(51) Int. Cl. G11B 7/00

(52) U.S. Cl. 369/53.2; 369/53.31; 369/94

(57) ABSTRACT

A recording device, which writes data to a recording medium in which a data area and a middle area are disposed adjacent to each other, includes: an area expanding unit expanding the middle area to reduce the data area; a first writing unit writing data to the reduced data area; and a second writing unit writing a terminator to a vacant area of the data area to which the data has been written.

### CROSS-REFERENCE TO THE INVENTION

This application is based upon and claims the benefit of priority from the prior Japanese Patent Application No. 2006-182102, filed on Jun. 30, 2006; the entire contents of which are incorporated herein by reference.

### BACKGROUND OF THE INVENTION

1. Field of the Invention

The present invention relates a recording device that records information to a recording medium such as an optical disk and to a recording method thereof.

2. Description of the Related Art

In recent years, DVDs (Digital Versatile Disks) have come into practical use as large-capacity optical disks. As recordable DVDs, a write-once read-many DVD-R, a rewritable DVD-RW, a DVD-RAM, and the like have been standardized.

A standard of a DVD with an increased recording capacity has been also proposed. Possible methods to increase the recording capacity are to narrow the size of beam spots (to shorten the wavelength of laser beams, to increase an numerical aperture NA, and so on), to dispose recording layers on both sides of an optical disk, to dispose a plurality of recording layers on one side of an optical disk, and so on. In a case where a data volume to be recorded to the optical disk is small, increasing the recording capacity of an optical disk may possibly lead to a long finalization time, and as a result, to a decrease in the data write speed.

There is disclosed an art to set a range of a data write area based on the total volume of data to be recorded (see JP-A 2004-342217 (KOKAI), paragraph No. 0073).

### SUMMARY OF THE INVENTION

It is an object of the present invention to provide a recording device realizing a shorter finalization time and a recording method therefor.

A recording device according to one aspect of the present invention is a recording device writing data to a recording medium in which a data area and a middle area are disposed adjacent to each other, and the recording device includes: an area expanding unit expanding the middle area to reduce the data area; a first writing unit writing data to the reduced data area; and a second writing unit writing a terminator to a vacant area of the data area to which the data has been written.

A recording method according to another aspect of the present invention is a recording method of writing data to a recording medium in which a data area and a middle area are disposed adjacent to each other, and the method includes: expanding the middle area to reduce the data area; writing data to the reduced data area; and writing a terminator to a vacant area of the data area to which the data has been written.

### BRIEF DESCRIPTION OF THE DRAWINGS

FIG. 1 is a block diagram showing an optical disk device according to one embodiment of the present invention.

FIG. 2 is a schematic view showing an example of the internal structure of recording layers of an optical disk.

FIG. 3 is a schematic view showing an example of the internal structure of expanded middle areas.

FIG. 4 is a schematic view showing another example of the internal structure of the expanded middle areas.

FIG. 5 is a view showing an example of a case where the middle areas are not expanded.

FIG. 6 is a view showing an example of a case where the middle areas are expanded.

FIG. 7 is a view showing another example of the case where the middle areas are not expanded.

FIG. 8 is a view showing another example of the case where the middle areas are expanded.

FIG. 9 is a flowchart showing an example of the operation procedure of the optical disk device.

### DESCRIPTION OF THE EMBODIMENTS

Hereinafter, an embodiment of the present invention will be described in detail with reference to the drawings.

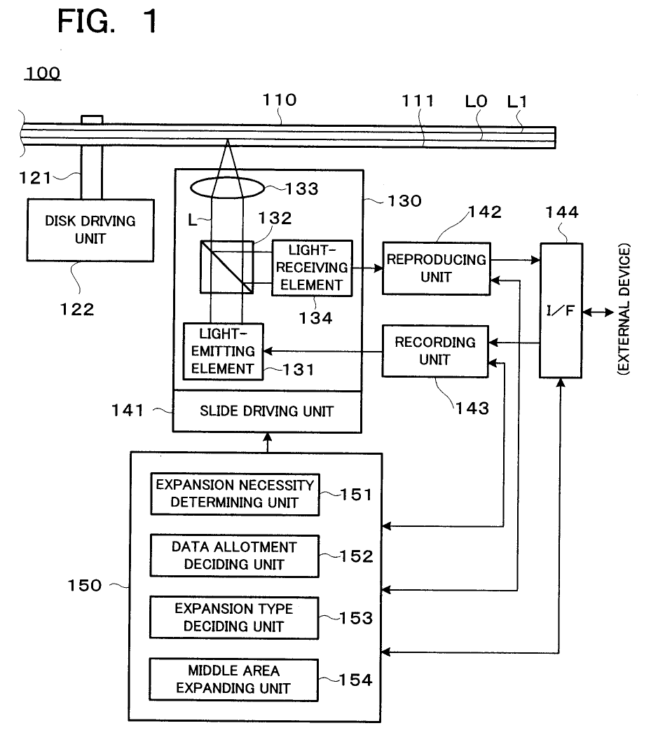

FIG. 1 is a block diagram showing an optical disk device 100 according to one embodiment of the present invention. The optical disk device 100 records/reproduces information to/from an information recording medium such as an optical disk 110.

The optical disk 110 has recording layers L0, L1 disposed in order from a reading surface 111. Details of the optical disk 110 will be described later.

The optical disk device 100 has an optical disk support unit 121, an optical disk driving unit 122, an optical pickup 130, a slide driving unit 141, a reproducing unit 142, a recording unit 143, an interface 144, and a control unit 150.

The optical disk support unit 121 supports the optical disk 110.

The optical disk driving unit 122 rotates the optical disk support unit 121 to rotate the optical disk 110.

The optical pickup 130 radiates laser beams to the recording layers L0, L1 of the optical disk 110 and converts reflected light thereof to an electrical signal to output the electrical signal as an RF signal. The optical pickup 130 has a light-emitting element 131, abeam splitter 132, an objective lens 133, and a light-receiving element 134. The laser beams radiated from the light-emitting element 131 pass through the beam splitter 132 to be focused on the recording layers L0, L1 of the optical disk 110 by the objective lens 133. The focused laser beams are reflected on the recording layers L0, L1 of the optical disk 110 and are changed in direction by the beam splitter 132 to be received by the light-receiving element 134 and converted to the electrical signal (RF signal).

The slide driving unit 141 moves the optical pickup 130 in a direction of the diameter of the optical disk 110.

The reproducing unit 142 processes the RF signal outputted from the optical pickup 130 to reproduce information.

The recording unit 143 writes information to the optical disk 110 by controlling the light-emitting element 131. The recording unit 143 functions as a first writing unit writing data to a data area and as a second writing unit writing a terminator to a vacant area of the data area.

The interface 144 connects the optical disk device 100 and an external device (for example, a computer).

The control unit 150 controls the recording and reproduction of information to/from the optical disk 110. The control unit 150 has an expansion necessity determining unit 151, a data allotment deciding unit 152, an expansion type deciding unit 153, and a middle area expanding unit 154.

The expansion necessity determining unit 151 determines whether or not the expansion of middle areas, which will be described later, of the optical disk 110 is necessary.

The data allotment deciding unit 152 decides the allotment (allocation) of data to the first and second recording layers L0, L1 of the optical disk 110.

The expansion type deciding unit 153 decides the type of the expansion of the middle areas of the optical disk 110.

The middle area expanding unit 154 expands the middle areas of the optical disk 110 according to the type decided by the expansion type deciding unit 153.

### (Details of the Optical Disk)

Examples of the optical disk 110 are DVD-R, DVD-RW, DVD-RAM, HD DVD-R, HD DVD-RW, and HD DVD-RAM.

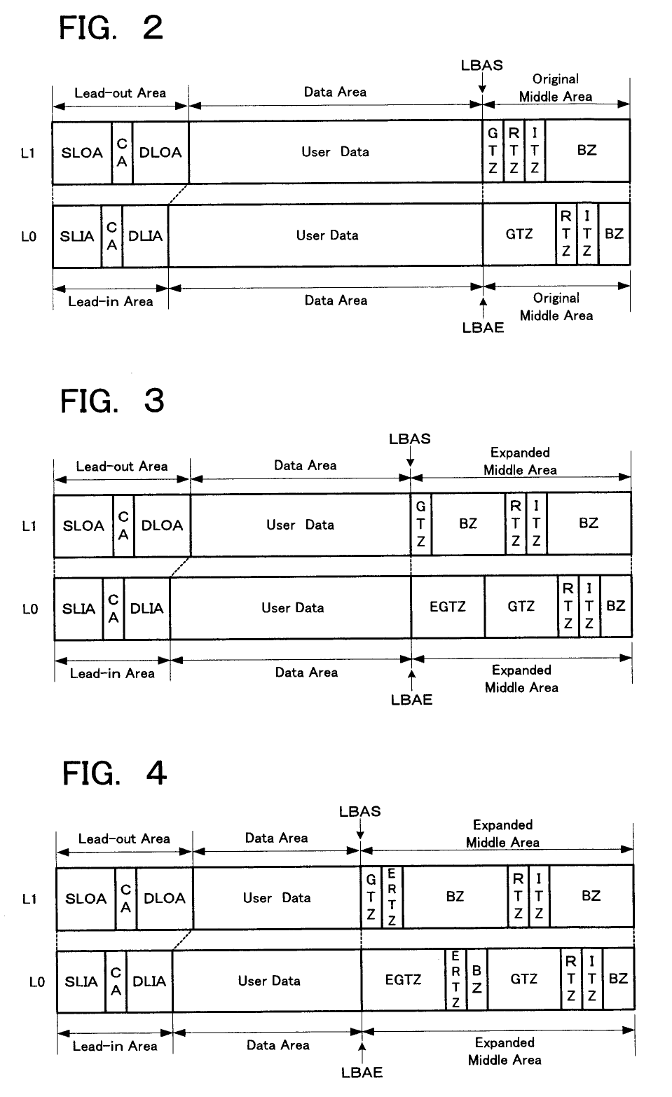

FIG. 2 is a schematic view showing an example of the internal structure of the recording layers L0, L1 of the optical disk 110.

In the recording layer L0, a lead-in area, a data area, and a middle area are disposed in this order from an inner circumference side. In the recording layer L1, a lead-out area, a data area, and a middle area are disposed in this order from an inner circumference side. On a further inner circumference side of the lead-in area, a burst cutting area BCA is disposed.

In the lead-in area, a system lead-in area SLIA, a connection area CA, and a data lead-in area DLIA are disposed in this order from the innermost circumference of the optical disk 110.

The data lead-in area DLIA has a management area and is disposed only in the recording layer L0. At the time of the finalization of the recording layer L1, information recorded in the recording layer L1 is also written to the data lead-in area DLIA of the recording layer L0. This makes it possible to obtain management information of both the recording layer L0 and the recording layer L1 by reading only the recording layer L0 at the time of activation. This management area includes a recording position management zone and an R-physical format information zone. Information relating to the expansion of the middle areas is written to the recording position management zone. Information on a halfway point, which will be described later, is recorded to the R-physical format information zone.

In the lead-out area, a system lead-out area SLOA, a connection area CA, and a data lead-out area DLOA are disposed in this order from the innermost circumference of the optical disk 110. The data areas are areas to which user data such as main data is recorded. The recording direction of the user data to the data area at this time is from an inner circumference toward an outer circumference in the recording layer L0, and from an outer circumference toward an inner circumference in the recording layer L1. The write of the user data to the recording layer L1 is started after data is written to the whole data area of the recording layer L0.

An end address of the data area of the recording layer L1 (logic block address on the inner circumference side) is disposed on a more outer circumference side than a start address (logic block address on the inner circumference side) of the data area of the recording layer L0. On the other hand, an end address LBAE of the data area of the recording layer L0 (logic block address on the outer circumference side) and a start address LBAS of the data area of the recording layer L1 (logic block address on the outer circumference side) match each other within a clearance range. These addresses (logic block addresses) LBAE, LBAS correspond to the halfway point at which a recording layer is changed from the recording layer L0 to the recording layer L1.

In each of the middle areas of the recording layer L0 and the recording layer L1, a guard track zone GTZ, a drive test zone RTZ, a disk test zone ITZ, and a blank zone BZ are disposed in this order from the inner circumference side.

The guard track zone GTZ of the recording layer L0 is provided for recording data of the drive test zone RTZ and the disk test zone ITZ of the recording layer L1. Therefore, an end position of the guard track zone GTZ of the recording layer L0 is positioned on a more outer circumference side than a start position of the disk test zone ITZ of the recording layer L1 at least by a clearance amount.

The blank zone BZ of the recording layer L1 is provided for recording data of the drive test zone RTZ and the disk test zone ITZ of the recording layer L0. Therefore, an end position of the black zone BZ of the recording layer L1 is positioned on a more inner circumference side than a start position of the drive test zone RTZ of the recording layer. L0 at least by a clearance amount.

The middle areas can be expanded. The expansion of the middle areas means to expand the capacity of the middle areas.

FIG. 3 and FIG. 4 are schematic views showing examples (expansion 1 and expansion 2) of the internal structure of the expanded middle areas. The expansion 1 (FIG. 3) and the expansion 2 (FIG. 4) are different in expansion size of the middle areas. The expansion 1 is small in the expansion size and the expansion 2 is large in expansion size. Concretely, the expansion 1 or the expansion 2 is selected according to whether or not the expansion size of the middle area is smaller than 17000 h sectors.

In the expansion 1, an extra guard track zone EGTZ is additionally disposed on the inner circumference side of the guard track zone GTZ of the recording layer L0, and a blank zone BZ is additionally disposed between the guard track zone GTZ and the drive test zone RTZ of the recording layer L1. That is, the extra guard track zone EGTZ and the blank zone BZ are added, so that the guard track zones GTZ are moved.

In the expansion 2, a blank zone BZ, an extra drive test zone ERTZ, and an extra guard track zone EGTZ are additionally disposed on the inner circumference side of the guard track zone GTZ of the recording layer L0. Further, a blank zone BZ and an extra drive test zone ERTZ are disposed between the guard track zone GTZ and the drive test zone RTZ of the recording layer L1. That is, the extra guard track zone EGTZ, the blank zones BZ, and the extra drive test zones ERTZ are added, so that the guard track zones GTZ are moved.

The optical disk 110 has the drive test zones on the inner circumference side and the outer circumference side and sets various recording conditions by using the drive test zones. The recording conditions change depending on each recording position. That is, the recording conditions are set in a place near a position to which the recording is actually performed, so that recording grade is improved.

In the expansion 2, an expansion amount of the middle area is large. In this case, it is thought that portions close to an outer circumference in the data areas for recording may possibly be apart from the drive test zones RTZ. In this case, by using the newly set extra drive test zones ERTZ, it is possible to set the recording conditions. That is, vacant areas produced due to the reduction of the data areas are usable as drive test zones. As a result, a write test of the drive can be conducted at places closer to the data areas, leading to improved recording grade.

Incidentally, the middle areas are expanded by updating the recording position management zone of the data lead-in area. This applies both to the expansions 1 2.

The expansion of the middle areas results in a reduction in the data areas. As a result, it is possible to reduce a data volume of a terminator TM for finalization, which can shorten the finalization time. For example, suppose a case where user data with a volume writable to the recording layer L0 is written to the recording layers L0, L1. If the user data is written with no expansion of the middle areas, large vacancy (vacant area) remains in the data areas. Therefore, it is expected that the finalization of the optical disk 110 takes a long time. This is because the vacant areas of the data areas have to be padded with a terminator TM at the finalization. The expansion of the middle areas reduces the data areas, that is, reduces the vacant area, by an expansion volume of the middle areas, so that the finalization time is shortened.

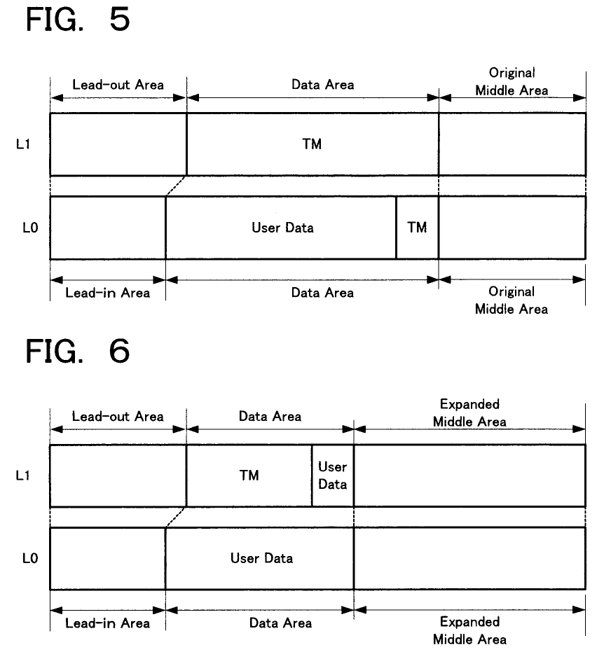

FIG. 5 and FIG. 6 are views showing examples of a case where the middle areas are expanded and a case where the middle areas are not expanded, respectively. In the case where the middle areas are not expanded (FIG. 5), data is written only to the recording layer L0 of the optical disk 110. In the case where the middle areas are expanded (FIG. 6), user data is written both to the recording layers L0, L1 after the middle areas of the optical disk 110 are expanded. That is, the data with a volume writable to the recording layer L0 is divided to be written to the recording layers L0, L1. The expansion of the middle areas reduces the data areas, so that the finalization time is shortened. Further, since the user data is written to areas close to the inner circumferences of both the recording layers L0, L1, access speed and writing grade are improved.

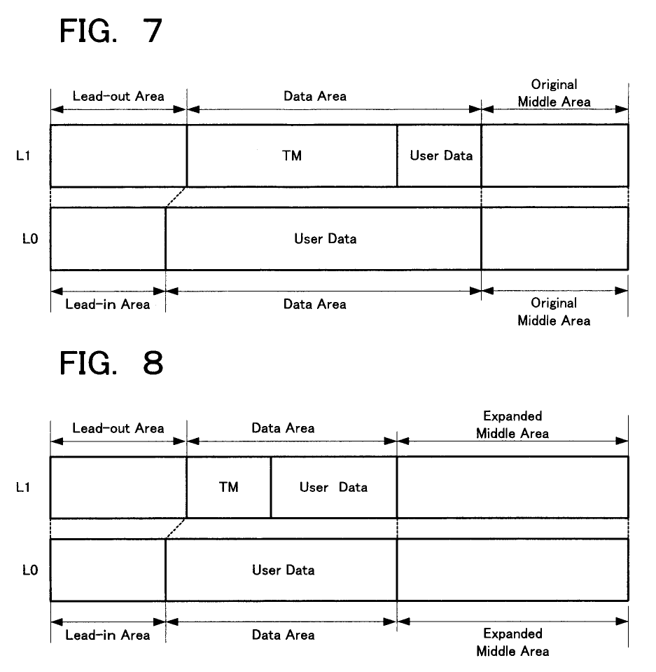

FIG. 7 and FIG. 8 are views showing other examples of the case where the middle areas are not expanded and the case where the middle areas are expanded, respectively. In both FIG. 7 and FIG. 8, user data is written both to the recording layers L0, L1 of the optical disk 110. Also when a data volume covers two layers, expanding the middle areas reduces a vacant capacity, so that the finalization time is shortened. Further, since the arrangement of the user data is changed (the user data is written to an inner circumference side of the optical disk 110), it is possible to improve access speed and writing grade.

### (Operation of the Optical Disk Device 100)

The operation of the optical disk device 100 will be described.

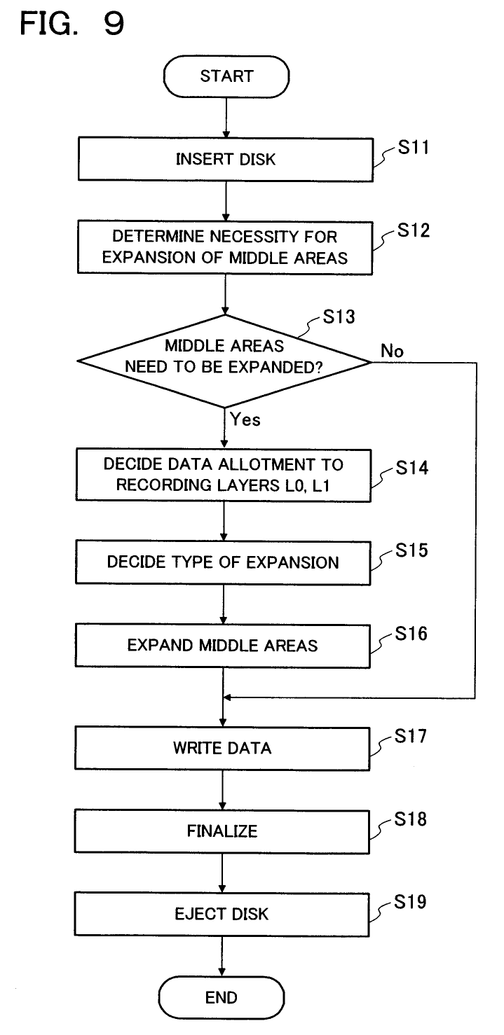

FIG. 9 is a flowchart showing an example of the operation procedure of the optical disk device 100. Hereinafter, the operation procedure of the optical disk device 100 will be described based on FIG. 9.

### A. Insert Optical Disk 110 (Step S11)

The optical disk 110 is inserted in the optical disk device 100. When the optical disk 110 is inserted, the operation is started. The optical disk 110 at this time may have no recorded data or may have recorded data in part. It is assumed that the optical disk 110 has not been finalized.

Data in the burst cutting area (BCA) of the optical disk 110 is read, whereby the type of the optical disk is determined. The types of optical disks include one-sided/two-sided types, one layer/two layer types, reproduction only/write-once read-many/rewritable types, and so on. For example, the optical disk 110 is determined as a one-sided two-layer optical disk.

### B. Determine Necessity for Expansion of Middle Areas (Step S12)

The expansion necessity determining unit 151 determines whether or not the expansion of the middle areas is necessary. The middle areas are expanded when all the following conditions (1) to (3) are satisfied.

### (1) A finalization process is executed after data is written.

### (2) A vacant capacity of the whole data areas of the optical disk 110 is larger than a volume of data to be written.

### (3) The data area of the recording layer L0 has a vacant area.

Here, the conditions (1), (2) mean that it is necessary to write a terminator to the data area(s) if the middle areas are not expanded. In this embodiment, by the expansion of the middle areas, the time to write the terminator is shortened.

The condition (3) means that user data is written to the data area of the recording layer L0. If there is no vacant area in the data area of the recording layer L0, the middle areas are not expanded. The expansion of the middle areas is not executed separately in the recording layers L0, L2.

Here, the execution or not of the finalization and the volume of the data to be written are notified from an external device. It is possible to find a vacant capacity of the whole data areas (both the recording layers L0, L1) and a vacant capacity of the recording layer L0, by reading data from the management area of the optical disk 110.

### C. Decide Allotment of Data (Steps S13, S14)

In a case where the middle areas are expanded, the data allotment deciding unit 152 decides the allotment of data to the recording layers L0, L2. This decision takes the following steps (1), (2).

### (1) Calculation of the Total Volume of User Data of the Disk 110

The total volume of user data, that is, the sum of a written data volume and the volume of the data to be written is calculated. By reading the data from the management area, it is possible to find the written data volume. The volume of the data to be written is notified from the external device. The addition of these data volumes gives the total volume of the user data of the disk 110.

### (2) Decision of an End Address of the Recording Layer L0.

Based on the total volume of the written data and the data to be written, the end address (logic block address) of the recording layer L0, that is, the allotment of the data to the recording layers L0, L1 is decided.

At this time, the interlayer halfway point after the data is written to the optical disk 110 is set on as inner circumference side of the optical disk 110 as possible. To decide this, the minimum size of data write (for example, the size of an ECC block) is taken into consideration.

### D. Decide Classification of Expansion of Middle Areas (Step S15)

As previously described, the expansion of the middle areas is classified into two types (the expansion 1 and the expansion 2) according to the expansion size. It is decided which one of these two types of expansion is used. This is decided based on an interval between the halfway position of the recording layers L0, L1 and an end position of the recorded area of the recording layer L0.

When the interval between the halfway position of the recording layers L0, L1 and the end position of the recorded area (difference between logic block addresses) is smaller than a predetermined value (for example, 17000h sectors), the expansion 1 is selected, and when this interval is larger than the predetermined value, the expansion 2 is selected.

### E. Expand Middle Areas (Step S16)

The middle areas are expanded. The data areas are reduced as a result of the expansion of the middle areas.

In the expansion 1, the extra guard track zone EGTZ of the recording layer L0 is formed, and the blank zone BZ of the recording layer L1 is formed, so that the guard track zone GTZ of the recording layer L1 is rearranged.

In the expansion 2, the extra drive test zone ERTZ and the blank zone BZ are further formed in the recording layer L0, and the extra drive test zone ERTZ is further formed in the recording layer L1.

The data in the recording position management zone is updated, so that the middle areas are expanded. Further, the expansion of the middle areas is followed by a change of the end address LBAE of the data area of the recording layer L0. The changed end address LBAE is recorded in the R-physical format information zone.

Incidentally, in a case where the terminator is not adjacent to the middle area, it is not necessary to add the guard track zones GTZ of the recording layer L0, L1 and the extra guard track zone EGTZ of the recording layer L0.

### F. Record Data to Recording Layers L0, L1 (Step S17)

### (1) Padding

Prior to the recording to the recording layer L1, a predetermined zone of the recording layer L0 is padded with “00h” (padding). This is to prevent the state of the recording layer L0 from affecting the recording and reproduction of the recording layer L1 (occurrence of interlayer cross talk). In the case where the middle areas are not expanded, the guard track zone GTZ in the middle area of the recording layer L0 is padded. In the case of the expansion 1, the extra guard track zone EGTZ and the guard track zone GTZ in the middle area of the recording layer L0 are padded. In the case of the expansion 2, the extra guard track zone EGTZ in the middle area of the recording layer L0 is padded.

As will be described later, the above padding can be executed in advance prior to the data recording or the finalization.

### (2) Recording of User Data

User data is recorded to the data area of the recording layer L0. When necessary, the user data is recorded to the data area of the recording layer L1 in addition to the data area of the recording layer L0.

### G. Finalize (Step S18)

### (1) Write of the Terminator

In the case where the data areas are finalized, the terminator TM is recorded to an unrecorded portion of the data areas. Main data of the terminator TM is set to “00 h”.

In a case where the recording of the user data is completed halfway in the data area of the recording layer L0, the terminator TM is recorded both to the recording layers L0, L1.

In a case where the recording of the user data is completed halfway in the data area of the recording layer L1, the terminator TM is recorded only to the recording layer L1.

In a case where the user data is recorded to the whole data area of the recording layer L1, the terminator TM is not recorded.

### (2) Padding

A predetermined zone in the data lead-in area of the recording layer L0 and a zone in the data lead-out area of the recording layer L1 are padded. As will be described later, this padding can be executed in advance prior to the data recording or the finalization.

### H. Eject Optical Disk 110 (Step S19)

The optical disk 110 to which the data has been recorded is ejected.

As described above, in this embodiment, the data write areas are reduced according to a volume of data to be written, thereby reducing a vacant capacity. As a result, the finalization time can be shortened.

Further, taking the interlayer halfway position into consideration, the data recording areas are disposed in an inner circumference portion so as to reduce the vacant capacities of both the recording layers L0, L2. As a result, the access time is shortened and recording grade is improved.

To prevent the state of the recording layer L0 from affecting the recording and reproduction of the recording layer L1 (occurrence of the interlayer crosstalk), it is necessary that data has been recorded to the recording layer L0 before the recording to the recording layer L1. That is, prior to the recording to the data area of the recording layer L1, it is necessary that data has been recorded to the data area of the recording layer L0 and predetermined places of the lead-in area and the middle area of the recording layer L0 have been padded. In this case, it is possible to pad the predetermined places of the lead-in area and the middle area after the recording to the data area of the recording layer L0, and then to execute the recording to the recording layer L1.

On the other hand, part of the padding can be executed prior to the data recording or the finalization, as described above. That is, in an idle time after the insertion of the optical disk 110, the padding is executed as a pre-process. Using the idle time for padding the predetermined places of the lead-in area and the middle area makes it possible to shorten the time for the data recording and the finalization.

The guard area of the lead-in area and the guard area (guard track zone GTZ) of the middle area can be padded irrespective of whether or not the middle areas are expanded. The extra guard track zone EGTZ is additionally padded in the case where the middle areas are expanded.

### OTHER EMBODIMENTS

The above-described embodiment is not intended to limit the present invention and can be expanded and modified, and the modified and changed embodiments are also included in the technical scope of the present invention. The above embodiment describes the case where the number of the recording layers is two. The present invention is also applicable to a case where the number of the recording layers is 3 or more.

What is claimed is:

1. A recording device that writes data to a recording medium in which a data area and a middle area are disposed adjacent to each other, the device comprising:
an area expanding unit expanding the middle area to reduce the data area;
a first writing unit writing data to the reduced data area; and
a second writing unit writing a terminator to a vacant area of the data area to which the data has been written.

2. The recording device as set forth in claim 1, further comprising:
an area adding unit adding a drive test area in the middle area which is to be expanded.

3. The recording device as set forth in claim 1,
wherein the recording medium has a lead-in area, and the device further comprising
a third writing unit padding a guard track zone of the lead-in area and a guard track zone of the middle area before the data is written to the data area.

4. The recording device as set forth in claim 1, further comprising
a determining unit determining whether or not the middle area needs to be expanded, based on a volume of the data to be written and a vacant capacity of the data area, and
wherein the area expanding unit expands the middle area when the determining unit determines that the middle area needs to be expanded.

5. The recording device as set forth in claim 1,
wherein the recording medium has a first and a second recording layer in each of which the data area and the middle area are disposed adjacent to each other and which are disposed in order from a reading surface.

6. The recording device as set forth in claim 5, further comprising
a determining unit determining whether or not the middle areas need to be expanded, based on a vacant capacity of the data area of the first recording layer, and
wherein the area expanding unit expands the middle areas when the determining unit determines that the middle areas need to be expanded.

7. The recording device as set forth in claim 5, further comprising
a first deciding unit deciding data allotment to the first and second recording layers, based on a total volume of data having been written to the data areas and data to be written.

8. The recording device as set forth in claim 5, further comprising
a second deciding unit deciding a type of the expansion of the middle areas, based on a total volume of data having been written to the data area of the first recording layer and data to be written, and
wherein the area expanding unit expands the middle area based on the decided type of the expansion.

9. A recording method of writing data to a recording medium in which a data area and a middle area are disposed adjacent to each other, the method comprising:
expanding the middle area to reduce the data area;
writing data to the reduced data area; and
writing a terminator to a vacant area of the data area to which the data has been written.

10. The recording method as set forth in claim 9, further comprising
adding a drive test area in the middle area which is to be expanded.

11. The recording method as set forth in claim 9,
wherein the recording medium has a lead-in area, and the method further comprising
padding a guard track zone of the lead-in area and a guard track zone of the middle area before the data is written to the data area.
